(19) United States
(12) Patent Application Publication
(10) Pub. No.: US 2016/0381700 A1
(43) Pub. Date: Dec. 29, 2016

(54) Dynamic Multicast Channel (MCH) Scheduling Information (MSI) in Reducing 1x Page Collision

(71) Applicant: QUALCOMM Incorporated, San Diego, CA (US)

(72) Inventors: Kuo-Chun Lee, San Diego, CA (US); Omar Sabbarini, San Diego, CA (US); Sivaramakrishna Veerepalli, San Diego, CA (US); Pavan Chaithanya Kaivaram, San Diego, CA (US); Jack Shyh-Hurng Shauh, San Diego, CA (US); Shailesh Maheshwari, San Diego, CA (US); Mohan Krishna Gowda, San Diego, CA (US); Jun Wang, Poway, CA (US)

(21) Appl. No.: 14/943,236

(22) Filed: Nov. 17, 2015

Related U.S. Application Data
(60) Provisional application No. 62/185,324, filed on Jun. 26, 2015.

(51) Int. Cl. H04W 72/12; H04W 28/04

(52) U.S. Cl. CPC H04W 72/1263; H04W 28/044

(57) ABSTRACT

Embodiments include methods to manage tune-away events on a multi-subscription multi-standby wireless communication device having an RF resource supporting a first subscription and a second subscription by changing an order of Multicast Traffic Channel (MTCH) transmissions across a number of Multicast Channel Scheduling Periods (MSPs). In various embodiments, the order of MTCH transmissions may be changed by rotating the Logical Channel Identifier (LCID) order in a Multicast Channel (MCH) Scheduling Information (MSI) Media Access Control (MAC) message sent from a serving base station or tower (e.g., a serving Evolved Node B (eNB)) to a multi-subscription multi-standby wireless communication device. In various embodiments, a multi-subscription, multi-standby wireless communication device may activate a MTCH for one or more service according to the dynamic MSI MAC message.

### RELATED APPLICATIONS

This application claims the benefit of priority to U.S. Provisional Application No. 62/185,324 entitled “Dynamic MSI in Reducing 1× Page Collision” filed Jun. 26, 2015, the entire contents of which are hereby incorporated by reference.

### BACKGROUND

Mobile communication devices may include one or more Subscriber Identity Module (SIM) cards that provide users with access to multiple separate mobile telephony networks. A mobile communication device that includes one or more SIMs and connects to two or more separate mobile telephony networks using one or more shared radio frequency (RF) resources/radios may be termed a “multi-subscription multi-standby” wireless communication device. An example is a dual-SIM-dual-standby (DSDS) communication device, which includes two SIM cards/subscriptions that are each associated with a separate radio access technology (RAT), and the separate RATs share one RF chain to communicate with two separate mobile telephony networks on behalf of their respective subscriptions. Another example is a single-radio Long Term Evolution (LTE) (SRLTE) communication device, which includes one SIM card/subscription associated with two RATs that share a single shared RF resource to connect to two separate mobile networks on behalf of the one or more subscriptions.

A plurality of RATs on a multi-subscription multi-standby wireless communication device may use one or more shared RF resources to communicate with their respective mobile telephony networks, and only one RAT may use each RF resource to communicate with its mobile network at a time. Even when a RAT is in an “idle-standby” mode, meaning it is not actively communicating with the network, the RAT typically needs to periodically receive access to a shared RF resource in order to perform various network operations. For example, an idle RAT may need the shared RF resource at regular intervals to perform idle mode operations, to receive network paging messages in order to remain connected to the network, etc. on behalf of the RAT's subscription. Therefore, it is possible that at a certain times the multiple RATs sharing an RF resource will need to use the RF resource to communicate with their respective mobile networks simultaneously.

### SUMMARY

Various embodiments provide methods to manage tune-away events on a multi-subscription multi-standby wireless communication device having an RF resource supporting a first subscription and a second subscription by changing an order of Multicast Traffic Channel (MTCH) transmissions across a number of Multicast Channel Scheduling Periods (MSPs). Various embodiments provide methods for generating a dynamic Multicast Channel (MCH) Scheduling Information (MSI) Media Access Control (MAC) message (MSI MAC message) that may include determining whether a change period has expired, updating a MSI MAC message by rotating Logical Channel Identifiers (LCIDs) in the MSI MAC message according to a LCID rotation scheme to generate a dynamic MSI MAC message in response to determining that the change period has expired, and sending the dynamic MSI MAC message to a multi-subscription multi-standby wireless communication device. In some embodiments, the LCID rotation scheme may be shifting an LCID order in the MSI MAC message left or right one or more LCID. In some embodiments, the change period may be a multiple of a 1× paging cycle. In some embodiments, the change period may begin at a System Frame Number (SFN) with no offset. In some embodiments, the change period may not be a multiple of a 1× paging cycle. In some embodiments, the change period may begin with an offset. In some embodiments, sending the dynamic MSI MAC message to a multi-subscription multi-standby wireless communication device may include sending the dynamic MSI MAC message to the multi-subscription multi-standby wireless communication device via an Evolved Node B (eNB).

Some embodiments may further include signaling the LCID rotation scheme to the multi-subscription multi-standby wireless communication device. In some embodiments, signaling the LCID rotation scheme to the multi-subscription multi-standby wireless communication device may include signaling the LCID rotation scheme by a MAC message, a user service description (USD), a Radio Resource Control (RRC) message, or a service provisioning message.

Various embodiments provide methods for activating a MTCH according to a dynamic MSI MAC message that may include receiving a dynamic MSI MAC message including LCIDs rotated according to a LCID rotation scheme and activating a MTCH for one or more service according to the dynamic MSI MAC message. In some embodiments, the service may be a Dynamic Adaptive Streaming Over Hypertext Transfer Protocol (DASH) service. In some embodiments, receiving the dynamic MSI MAC message may include receiving the dynamic MSI MAC message via an eNB.

Further embodiments may include a device including a processor configured with processor-executable instructions to perform operations of the methods described above. Further embodiments may include a device including means for performing functions of the methods described above. Further embodiments may include processor-readable storage media on which are stored processor executable instructions configured to cause a processor to perform operations of the methods described above.

### BRIEF DESCRIPTION OF THE DRAWINGS

The accompanying drawings, which are incorporated herein and constitute part of this specification, illustrate exemplary embodiments, and together with the general description given in the summary and the detailed description, serve to explain the features of the claims.

FIG. 1 is a data block diagram illustrating elements of an example Multicast Channel (MCH) Scheduling Information (MSI) Media Access Control (MAC) message.

FIG. 2 is a timeline diagram illustrating reception activities of a first RAT and a second RAT sharing an RF resource.

FIG. 3 is a component block diagram of a communication system suitable for use with various embodiments.

FIG. 4 is a component block diagram of a communication system suitable for use with various embodiments.

FIG. 5 is a component block diagram of a mobile communication device according to various embodiments.

FIG. 6 is a component block diagram of a base station or tower suitable for use with various embodiments.

FIG. 7 is a process flow diagram illustrating an embodiment method for generating a dynamic MSI MAC message according to a Logical Channel Identifier (LCID) rotation scheme.

FIG. 8 is a timeline diagram illustrating reception activities of a first RAT and a second RAT sharing an RF resource based on an embodiment dynamic MSI MAC message.

FIG. 9 is a timeline diagram illustrating reception activities of a first RAT and a second RAT sharing an RF resource based on an embodiment dynamic MSI MAC message.

FIG. 10 is a timeline diagram illustrating reception activities of a first RAT and a second RAT sharing an RF resource based on an embodiment dynamic MSI MAC message.

FIG. 11 is a process flow diagram illustrating an embodiment method for activating a Multicast Traffic Channel (MTCH) according to a dynamic MSI MAC message.

FIG. 12 is a component block diagram of a mobile communication device suitable for implementing various embodiments.

FIG. 13 is a component block diagram of a server suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

As used herein, the term “multi-subscription multi-standby wireless communication device” refers to any one or all of cellular telephones, smart phones, personal or mobile multi-media players, personal data assistants, laptop computers, tablet computers, smart books, palm-top computers, wireless electronic mail receivers, multimedia Internet-enabled cellular telephones, wireless gaming controllers, and similar personal electronic devices that includes one or more SIM cards, a programmable processor, memory, and circuitry for connecting to at least two mobile communication network with one or more shared RF resources. Various embodiments may be useful in mobile communication devices, such as smart phones, and so such devices are referred to in the descriptions of various embodiments. However, the embodiments may be useful in any electronic devices that may individually maintain a plurality of RATs that utilize at least one shared RF chain, which may include one or more of antennae, radios, transceivers, etc. For example, various embodiments may be useful in SRLTE communication devices.

In conventional multi-subscription multi-standby wireless communication devices, the RAT actively using an RF resource that is shared with an idle RAT may occasionally be forced to interrupt RF operations so that the idle RAT may use the shared RF resource to perform idle-standby mode operations (e.g., paging monitoring, cell reselection, system information monitoring). This process of switching access of the shared RF resource from the active RAT to the idle RAT is sometimes referred to as a “tune-away” or a “tune-away event,” as the RF resource must tune away from the frequency bands and/or channels of the active RAT and must tune to frequency bands/channels of the idle RAT. After network communications over the idle RAT (sometimes collectively referred to herein as “tune-away” operations) are complete, the communication device may switch RF resource access back from the idle RAT to the active RAT.

Conventional multi-subscription multi-standby wireless communication devices supporting one or more RATs, including an active (or “first”) RAT and an idle (or “second”) RAT, occasionally need to tune away from the first RAT to the second RAT in order to enable the second RAT to perform various tune-away operations. Tune-away operations may include one or more of page monitoring (e.g., discontinuous reception), system information monitoring (e.g., receiving and decoding a broadcast control channel), cell reselection measurements to determine whether to initiate reselection operations to a neighboring cell, updating the second RAT network with the current location of the multi-subscription multi-standby wireless communication device, receiving Short Message Service (SMS) messages, and receiving mobile-terminated calls.

During the tune-away event, communication activities using the first RAT may be interrupted and data may be partially or entirely lost, which may degrade overall reception performance over the first RAT. Tune-away events may be especially disruptive to the first RAT's reception service and performance in situations in which the first RAT is prevented from receiving time-sensitive data, such as when the first RAT receives streaming multimedia (e.g., video and audio data segments) via multi-media broadcast multicast services over LTE, such as the Evolved Multimedia Broadcast Multicast Service (eMBMS). As a specific example, segments of a Dynamic Adaptive Streaming Over Hypertext Transfer Protocol (DASH) service carried on a Multicast Traffic Channel (MTCH) lost due to tune-away events may reduce the quality of the DASH service (e.g., increase the video segment loss rate) carried on the impacted MTCH.

In conventional networks, scheduled transmissions (e.g., Multicast Traffic Channel (MTCH) transmissions for logical channels assigned to multicast services, such as DASH services) for the first RAT actively using the shared RF resource may occur on in an unchanging sequential order every periodic cycle, such as once every Multicast Channel Scheduling Period (MSP) in assigned Logical Channel Identifier (LCID) order. Additionally, idle-standby mode operations for the idle RAT may be scheduled to be performed on an unchanging periodic cycle (e.g., a 1× page cycle). Because the order and periodic cycle of the scheduled transmissions for the RAT actively using the RF resource and the periodic cycle of the idle-standby mode operations of the idle RAT are both unchanging, as a result of the tune-away event to support the idle RAT, the same scheduled transmission may be missed each time a tune-away event occurs, thereby increasing the data loss rate for the impacted scheduled transmission on the active RAT. Tune-away events and transmission scheduling thus present a design and operational challenge for multi-subscription multi-standby wireless communication devices and other shared-radio devices, as well as network operators.

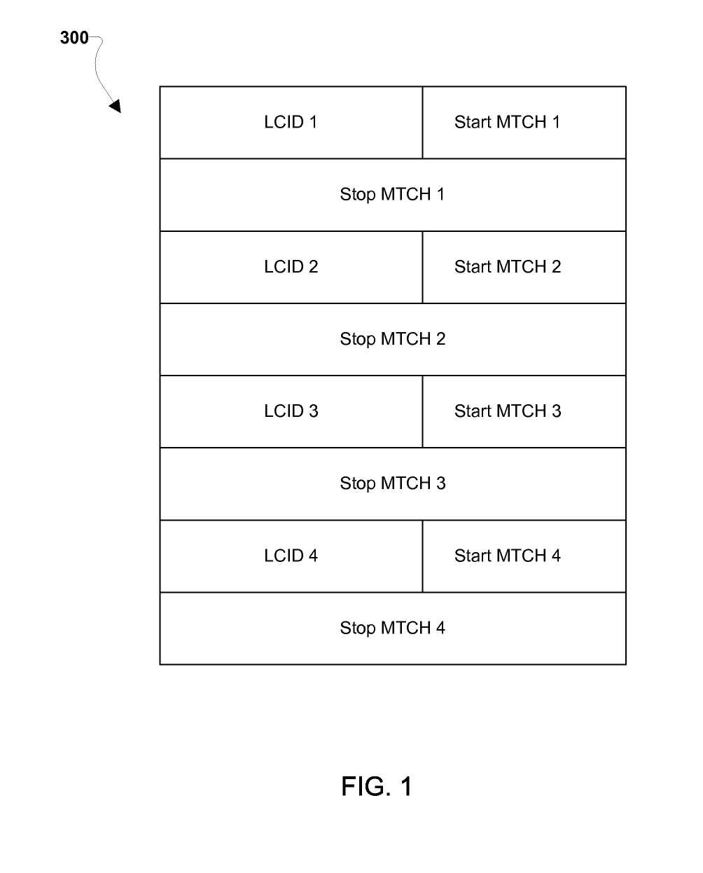

The order and periodic cycle may be signaled to a multi-subscription multi-standby wireless communication device by the serving base station or tower (e.g., an Evolved Node B (eNB)) in a message, such as a Multicast Channel (MCH) Scheduling Information (MSI) Media Access Control (MAC) message (MSI MAC message). An example MSI MAC message 300 is illustrated in FIG. 1. The MSI MAC message 300 may list the LCID (e.g., LCID 1, 2, 3, 4) assigned to each MTCH (e.g., MTCH 1, 2, 3, 4) and the start and stop subframes of each MTCH 1, MTCH 2, MTCH 3, and MTCH 4. The MTCHs 1, 2, 3, and 4 may repeat according to the start and stop subframes in the MSI MAC message 300 every MCH scheduling period (MSP) (e.g., every 320 milliseconds).

Each available service may be assigned its own MTCH. For example, a first DASH service streaming news videos may be assigned LCID 1 and segments of the first DASH service may be carried on MTCH 1, a second DASH service streaming sports videos may be assigned LCID 2 and segments of the second DASH service may be carried on MTCH 2, a third DASH service streaming music videos may be assigned LCID 3 and segments of the third DASH service may be carried on MTCH 3, and a fourth DASH service streaming movies may be assigned LCID 4 and segments of the fourth DASH service may be carried on MTCH 4.

Based on the timing indicated in the MSI MAC message 300, the MTCH 1, MTCH 2, MTCH 3, and MTCH 4 transmissions may occur in the sequence of subframes per MSP and may repeat in the same LCID order each successive MSP. According to the scheduling in the MSI MAC message 300, a multi-subscription multi-standby wireless communication device may receive data for a respective MTCH 1, 2, 3, or 4 from the serving base station or tower (e.g., the multi-subscription multi-standby wireless communication device's serving eNB) at the MTCH's assigned time per MSP.

In some situations, the idle-standby mode operations for the idle RAT may be scheduled to be performed on an unchanging periodic cycle (e.g., a 1× page cycle). To ensure the idle RAT does not miss a page (e.g., a MT paging message), the idle RAT may be configured to take control of the RF resource, thereby causing a tune away event, every 1× page cycle (e.g., every 2560 milliseconds) to listen for a page (e.g., a MT paging message).

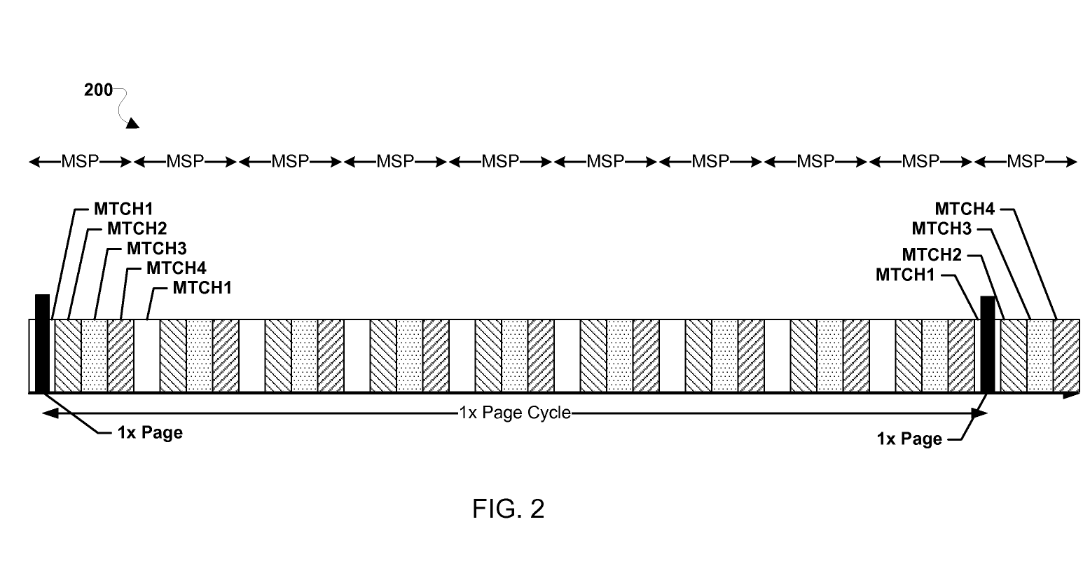

FIG. 2 illustrates a timeline 200 of an example of a 1× page event occurring once every 1× page cycle. The 1× page cycle may be a multiple of the MSP in some networks. For example, the MSP may be 320 milliseconds and the 1× page cycle may be 2560 milliseconds. Because the order and periodic cycle of the scheduled transmissions for the RAT actively using the RF resource and the periodic cycle of the idle-standby mode operations of the idle RAT are both unchanging in conventional networks, as a result of the tune-away event to support the idle RAT the same scheduled transmission may be missed each time a tune-away event occurs.

For example, as illustrated in timeline 200, the tune-away event for the 1× page may always occur during the scheduled subframes for MTCH 1 because the 1× page collides with the MTCH 1 transmission. Thus, the tune-away event for a 1× page will cause the data for MTCH 1 to be lost each time a tune-away event occurs, which will increase the data loss rate for the service carried on MTCH 1 compared with the services carried on MTCH 2, MTCH 3, and MTCH 4. Tune-away events and transmission scheduling thus present a design and operational challenge for multi-subscription multi-standby wireless communication devices and other shared-radio devices, as well as network operators.

Various embodiments provide methods to manage tune-away events on a multi-subscription multi-standby wireless communication device having an RF resource supporting a first RAT and a second RAT by changing an order of MTCH transmissions across a number of MSPs. The changing of an order of MTCH transmissions across a number of MSPs may reduce the loss rate experienced by a single MTCH during tune-away events as compared to the loss rate of that MTCH when the order of MTCH transmission does not change. The changing of an order of MTCH transmissions across a number of MSPs may reduce an amount of forward error correction (FEC) needed to support a selected data loss rate for a single MTCH (e.g., a selected segment loss rate for a DASH service) as compared to an amount of FEC required to meet the selected data loss rate of that MTCH when the order of MTCH transmission does not change.

In various embodiments, the order of MTCH transmissions may be changed by rotating the LCID order in a MSI MAC message sent from a serving base station or tower (e.g., a serving eNB) to a multi-subscription multi-standby wireless communication device. In this manner, various embodiments may provide a dynamic MSI MAC message. In some embodiments, the LCID order may be rotated by shifting the LCID order to the left one or more LCIDs. In some embodiments, the LCID order may be rotated by shifting the LCID order to the right one or more LCIDs. In various embodiments, the LCID order may be rotated once each change period. In some embodiments, the change period may be the same as the 1× paging cycle or may be a multiple of the 1× paging cycle of the idle RAT. In some embodiments, the change period may not be a multiple of the 1× paging cycle. In some embodiments, the change period may begin at the System Frame Number (SFN) with zero offset. In some embodiments, the change period may begin with an offset from the SFN applied.

In various embodiments, an LCID order in a dynamic MSI MAC message may be rotated by a network entity, such as base station or tower (e.g., an eNB), a Broadcast Multimedia Service Center (BMSC) server, a Mobility Management Entity (MME) server, a Multi-Cell/Multicast Coordination Entity (MCE) server, etc. In various embodiments, a dynamic MSI MAC message may be generated by a network entity on a per Multicast-broadcast single-frequency network (MBSFN) basis, and all base stations or towers in the MBSFN may send the same dynamic MSI MAC message.

In various embodiments, a scheme used to rotate LCIDs in dynamic MSI MAC messages may be signaled to multi-subscription multi-standby wireless communication devices served by a base station or tower (e.g., eNB) sending the dynamic MIS MAC message. In this manner, multi-subscription multi-standby wireless communication devices that do not receive the dynamic MIS MAC message may determine the likely next MTCH based on the signaled rotation scheme. As examples, the scheme used to rotate LCIDs in dynamic MSI MAC messages may be signaled to multi-subscription multi-standby wireless communication devices in a MAC message, in a user service description (“USD”), in a Radio Resource Control (RRC) message, or in a service provisioning message.

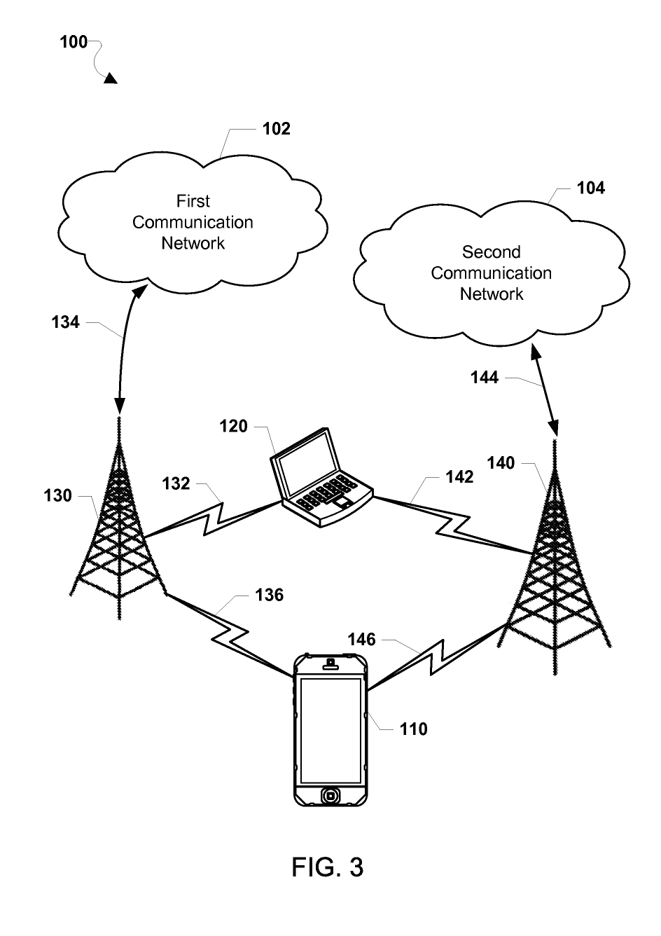

Various embodiments may be implemented within a variety of communication systems 100, such as systems that include at least two mobile communication networks, an example of which is illustrated in FIG. 3. With reference to FIGS. 1-3, a first communication network 102 and a second communication network 104 each may include a plurality of cellular base stations (e.g., a first base station 130 and a second base station 140). A first mobile communication device 110 may communicate with the first communication network 102 through a communication link 132 to the first base station 130. The first mobile communication device 110 may also communicate with the second mobile network 104 through a communication link 142 to the second base station 140. The first base station 130 may communicate with the first communication network 102 over a wired or wireless communication link 134, and the second base station 140 may communicate with the second communication network 104 over a wired or wireless communication link 144. The communication links 134 and 144 may include fiber optic backhaul links, microwave backhaul links, and other similar communication links. A second mobile communication device 120 may communicate with the first communication network 102 through a communication link 136 to the first base station 130, and with the second communication network 104 through a communication link 146 to the second base station 140.

Each of the communication networks 102 and 104 may support communications using one or more radio access technologies, and each of the communication links 132, 136, 142, and 146 may include cellular connections that may be made through two-way wireless communication links using one or more RATs. Examples of RATs include 3GPP Long Term Evolution (LTE), Worldwide Interoperability for Microwave Access (WiMAX), Code Division Multiple Access (CDMA), Time Division Multiple Access (TDMA), Wideband CDMA (WCDMA), Global System for Mobility (GSM), and other RATs. While the communication links 132, 136, 142, and 146 are illustrated as single links, each of the communication links may include a plurality of frequencies or frequency bands, each of which may include a plurality of logical channels. Additionally, each of the communication links 132, 136, 142, and 146 may utilize more than one RAT.

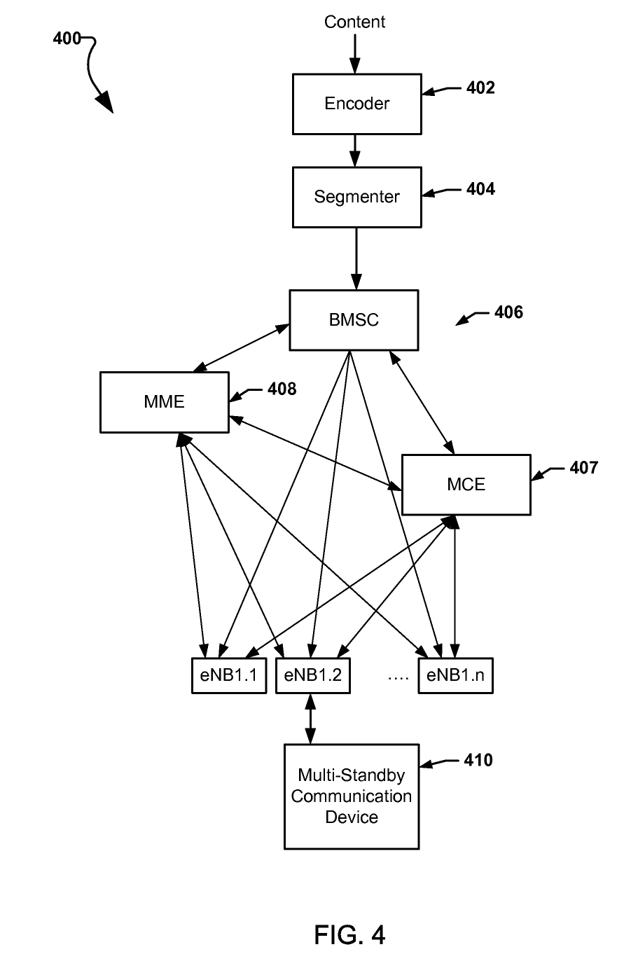

FIG. 4 illustrates the relationship between network entities and a multi-subscription multi-standby wireless communication device 410 (which may be similar to the multi-subscription multi-standby wireless communication device 110 in FIG. 3) along a delivery path for content of a service in a network 400, such as an Evolved Multimedia Broadcast Multicast Service (eMBMS) network (e.g., communication networks 102 and 104). With reference to FIGS. 1-4, the content from encoder 402 may pass from the encoder 402 to segmenter 404 and be provided to a portion of the network 400 served by a BMSC server 406. The BMSC server 406 may be connected to respective eNBs, eNB1.1, eNB1.2, eNB1.n, etc., and the BMSC server 406 may provide content for distribution to the multi-subscription multi-standby wireless communication device 410 served by the eNBs, such as eNB1.2. The BMSC server 406 may be connected to a MCE server 407, which may also be connected to respective eNBs, eNB1.1, eNB1.2, eNB1.n, etc., as well as a MME server 408 which may also be connected to respective eNBs, eNB1.1, eNB1.2, eNB1.n, etc. and/or the MCE server 407. The respective eNBs, eNB1.1, eNB1.2, eNB1.n, etc. may be similar to one or more of the base stations or towers 130 or 140.

The MCE server 407 may control the respective eNBs, eNB1.1, eNB1.2, eNB1.n, etc., and may group the eNBs into MBSFNs. The MME server 408 may control service signaling and provisioning to the multi-subscription multi-standby wireless communication device 410 via the respective eNBs, eNB1.1, eNB1.2, eNB1.n, etc.

In various embodiments, any of the network entities, such as the respective eNBs, eNB1.1, eNB1.2, eNB1.n, etc., the BMSC server 406, the MME server 408, and/or the MCE server 407 may change the order of MTCH transmissions by rotating the LCID order in a MSI MAC message. The MSI MAC message with the rotated LCID order (e.g., the dynamic MSI MAC message) may be sent from the serving eNB (e.g., eNB1.2) to the multi-subscription multi-standby wireless communication device 410. For example, the MSI MAC message may be sent in the first subframe of the first MTCH transmission of each MSP. The serving eNB (e.g., eNB1.2) may transmit data for the services with the LCIDs identified in the MSI MAC message with the rotated LCID order (e.g., the dynamic MSI MAC message) according to the schedule in the MSI MAC message, and the multi-subscription multi-standby wireless communication device 410 may use the MSI MAC message with the rotated LCID order (e.g., the dynamic MSI MAC message) to receive one or more of the services during the MSPs.

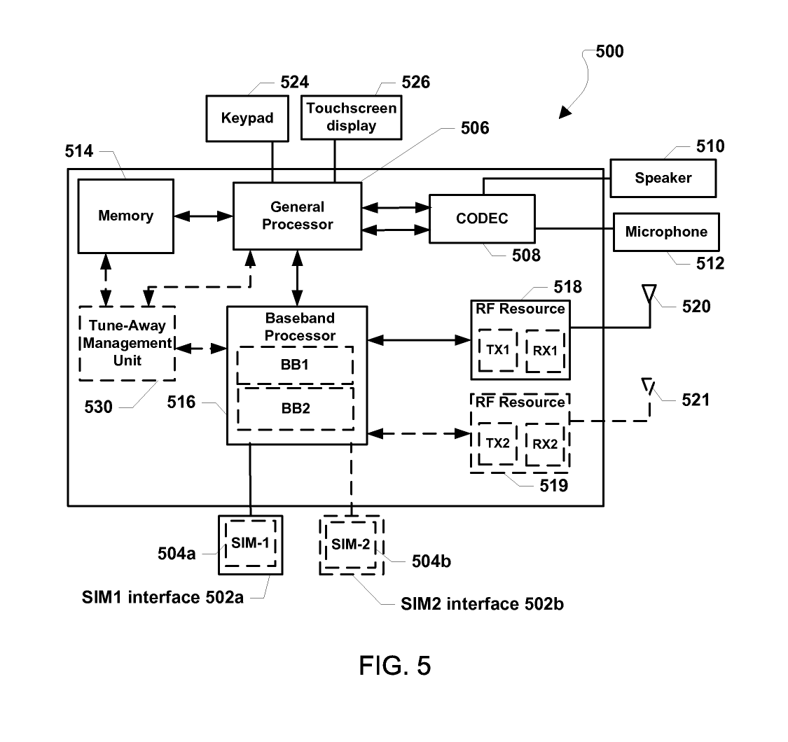

FIG. 5 is a component block diagram of a multi-subscription multi-standby wireless communication device 500 suitable for implementing various embodiments. With reference to FIGS. 1-5, in various embodiments, the multi-subscription multi-standby wireless communication device 500 may be similar to one or more of the multi-subscription multi-standby wireless communication devices 110, 120, or 410. The multi-subscription multi-standby wireless communication device 500 may include a first SIM interface 502a, which may receive a first identity module SIM-1 504a that may be associated with a first subscription. The multi-subscription multi-standby wireless communication device 500 may also optionally include a second SIM interface 502b, which may receive an optional second identity module SIM-2 504b that may be associated with a second subscription.

A SIM in various embodiments may be a Universal Integrated Circuit Card (UICC) that is configured with SIM and/or Universal SIM (USIM) applications, enabling access to GSM and/or Universal Mobile Telecommunications System (UMTS) networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the multi-subscription multi-standby wireless communication device, and thus need not be a separate or removable circuit, chip or card.

A SIM used in various embodiments may contain user account information, an international mobile subscriber identity (IMSI), a set of SIM application toolkit (SAT) commands and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider. An ICCID SIM serial number is printed on the SIM card for identification.

The mobile communication device 500 may include at least one controller, such as a general purpose processor 506, which may be coupled to a coder/decoder (CODEC) 508. The CODEC 508 may in turn be coupled to a speaker 510 and a microphone 512. The general purpose processor 506 may also be coupled to at least one memory 514. The memory 514 may be a non-transitory computer readable storage medium that stores processor-executable instructions. For example, the instructions may include routing communication data relating to the first or second subscription though a corresponding baseband-RF resource chain. The memory 514 may store an operating system (OS), as well as user application software and executable instructions. The memory 514 may also store application data, such as an array data structure.

The general purpose processor 506 and the memory 514 may each be coupled to at least one baseband modem processor 516. Each SIM and/or RAT in the mobile communication device 500 (e.g., the SIM-1 504a and/or the SIM-2 504b) may be associated with a baseband-RF resource chain. A baseband-RF resource chain may include the baseband modem processor 516, which may perform baseband/modem functions for communications with/controlling a RAT, and may include one or more amplifiers and radios, referred to generally herein as an “RF resource.” In some embodiments, baseband-RF resource chains may share the baseband modem processor 516 (i.e., a single device that performs baseband/modem functions for all RATs on the mobile communication device 500). In other embodiments, each baseband-RF resource chain may include physically or logically separate baseband processors (e.g., BB1, BB2).

An RF resource 518 may be a transceiver that performs transmit/receive functions for each of the SIMs/RATs on the mobile communication device. The RF resource 518 may include separate transmit and receive circuitry, or may include a transceiver that combines transmitter and receiver functions. In some embodiments, the RF resource 518 may include multiple receive circuitries. The RF resource 518 may be coupled to a wireless antenna (e.g., a wireless antenna 520). The RF resource 518 may also be coupled to the baseband modem processor 516.

In some optional embodiments, the mobile communication device 500 may include an optional RF resource 519 configured similarly to the RF resource 518 and coupled to an optional wireless antenna 521. In such embodiments, the mobile communication device 500 may leverage the multiple RF resources 518, 519 and antennae 520, 521 to perform diversity receiver reception during a tune-away event.

In some embodiments, the general purpose processor 506, the memory 514, the baseband processor(s) 516, and the RF resources 518, 519 may be included in the mobile communication device 500 as a system-on-chip. In some embodiments, the first and second SIMs 504a, 504b and their corresponding interfaces 502a, 502b may be external to the system-on-chip. Further, various input and output devices may be coupled to components on the system-on-chip, such as interfaces or controllers. Example user input components suitable for use in the mobile communication device 500 may include, but are not limited to, a keypad 524, a touchscreen display 526, and the microphone 512.

In some embodiments, the keypad 524, the touchscreen display 526, the microphone 512, or a combination thereof, may perform the function of receiving a request to initiate an outgoing call. For example, the touchscreen display 526 may receive a selection of a contact from a contact list or receive a telephone number. In another example, either or both of the touchscreen display 526 and the microphone 512 may perform the function of receiving a request to initiate an outgoing call. For example, the touchscreen display 526 may receive selection of a contact from a contact list or to receive a telephone number. As another example, the request to initiate the outgoing call may be in the form of a voice command received via the microphone 512. Interfaces may be provided between the various software modules and functions in the mobile communication device 500 to enable communication between them.

Functioning together, the two SIMs 504a, 504b, the baseband processor BB1, BB2, the RF resources 518, 519, and the wireless antennas 520, 521 may constitute two or more RATs. For example, the mobile communication device 500 may be an SRLTE communication device that includes a SIM, baseband processor, and RF resource configured to support two different RATs (e.g., LTE and GSM). More RATs may be supported on the mobile communication device 500 by adding more SIM cards, SIM interfaces, RF resources, and antennae for connecting to additional mobile networks.

In some embodiments (not illustrated), the mobile communication device 500 may include, among other things, additional SIM cards, SIM interfaces, a plurality of RF resources associated with the additional SIM cards, and additional antennae for connecting to additional mobile networks.

The mobile communication device 500 may optionally include a tune-away management unit 530 configured to manage the respective access of RATs associated with the first and second SIMs 504a, 504b to the RF resource 518 (and optionally the RF resource 519) in anticipation of or during a tune-away event. In some embodiments, the tune-away management unit 530 may determine whether to initiate a tune-away event from a first RAT to a second RAT or whether to prevent or block a tune-away event in order to improve data reception on the first RAT during the duration of the tune-away event. In some embodiments, the tune-away management unit 530 may be implemented within the general purpose processor 506. In other embodiments, the tune-away management unit 530 may be implemented as a separate hardware component (i.e., separate from the general purpose processor 506). In some embodiments, the tune-away management unit 530 may be implemented as a software application stored within the memory 514 and executed by the general purpose processor 506.

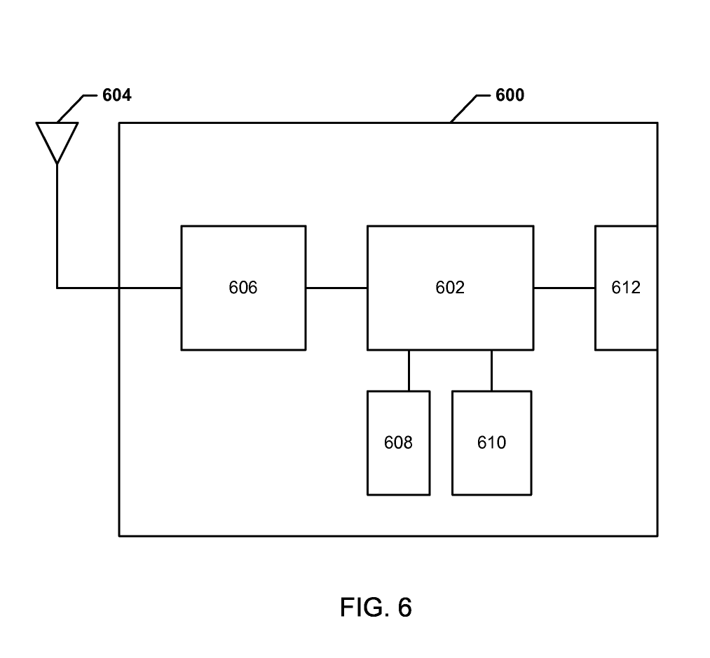

FIG. 6 is a component block diagram of a base station or tower, such as an eNB 600 suitable for implementing various embodiments. With reference to FIGS. 1-6, in various embodiments, the eNB 600 may be similar to one or more of the base stations or towers 130 or 140. Such an eNB 600 typically includes a processor 602 coupled to volatile memory 608 and a large capacity nonvolatile memory, such as a disk drive 610. The eNB 600 may include an antenna 604 coupled to a transceiver 606 that is coupled to the processor 602. Via the antenna 604 and transceiver 606 (e.g., a network interface) the processor may send/receive unicast and/or broadcast transmissions (e.g., CDMA, TDMA, GSM, PCS, 3G, 4G, LTE, Wi-Fi, and/or any other type of unicast and/or broadcast transmissions) to/from receiver devices. The eNB 600 may also include network access ports 612 (e.g., a network interface) coupled to the processor 602 for establishing network interface connections with a network, such as a local area network coupled to other broadcast system computers and servers, the Internet, the public switched telephone network, and/or a wireless data network (e.g., CDMA, TDMA, GSM, PCS, 3G, 4G, LTE, Wi-Fi, and/or any other type of wireless data network).

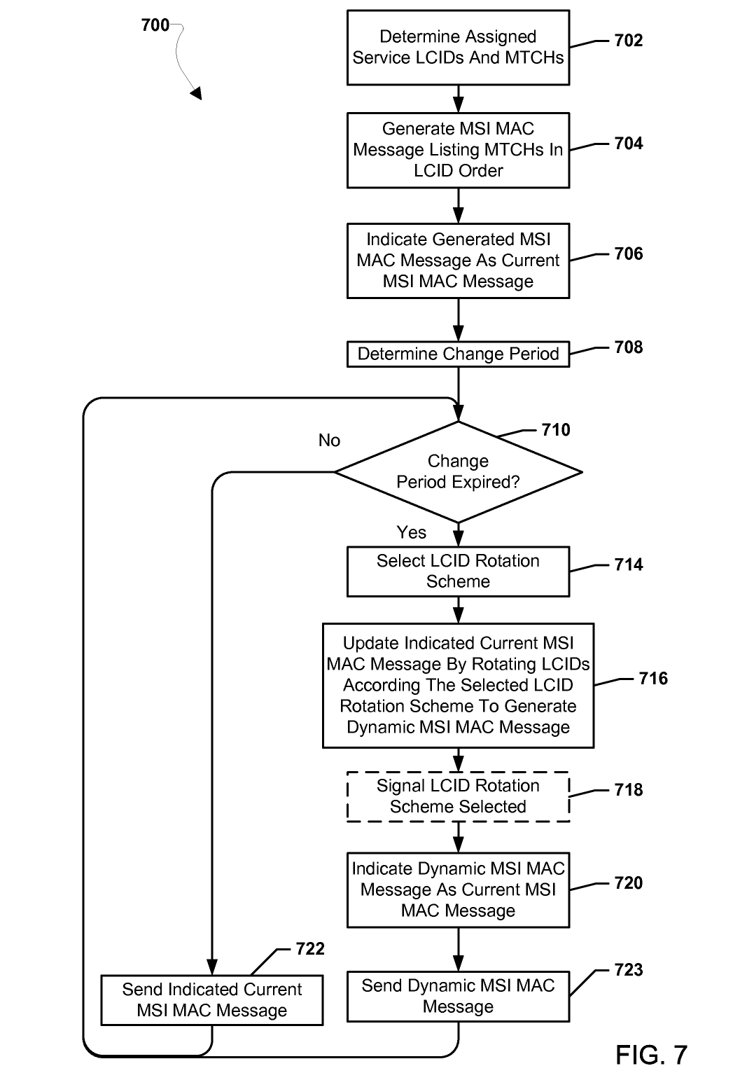

FIG. 7 illustrates a method 700 for generating a dynamic MSI MAC message according to a LCID rotation scheme according to various embodiments. With reference to FIGS. 1-7, the method 700 may be implemented by a processor of a network entity, such as a base station or tower processor (e.g., the processor 602 of the eNB 600, the processors of respective eNBs, eNB1.1, eNB1.2, eNB1.n, etc.), a network entity server processor (e.g., the processor of BMSC server 406, MME server 408, or MCE server 407, or processor of another network entity), etc.

In block 702, the network entity processor may determine the assigned service LCIDs and MTCHs to be transmitted to multi-subscription multi-standby wireless communication devices being served by the network entity. In various embodiments, LCIDs may be associated with services to be provided to multi-subscription multi-standby wireless communication devices in one or more MBSFN, and within an MBSFN the common LCID and MTCH may be assigned to a service.

In block 704, the network entity processor may generate a MSI MAC message listing MTCHs in LCID order. For example, the MSI MAC message may list the MTCHs for the services available in ascending order by LCID along with a sequence of subframes during a MSP, such as stop subframes, at which each of the MTCHs will be transmitted. In block 706, the network entity processor may indicate the generated MSI MAC message as the current MSI MAC message.

In block 708, the network entity processor may determine the change period. In some embodiments, the change period may be the same as a 1× paging cycle or may be a multiple of the 1× paging cycle. For example, the 1× paging cycle may be 2560 milliseconds and the MSP may be 320 milliseconds, resulting in the network entity processor determining a change period equal to the 1× paging cycle as equal to 8 MSPs. In some embodiments, the change period may not be a multiple of the 1× paging cycle. For example, the change period may be a preset number of MSPs, such as 6 MSPs.

In determination block 710, the network entity processor may determine whether the change period has expired. The change period may have expired, when a number of MSPs since the last generation or update of the MSI MAC message is equal to the number of MSPs in the change period. For example, the network entity processor may determine the change period has expired when the current MSP number is a multiple of the change period. In some embodiments, the change period may begin at the SFN with zero offset. For example, when the number of MSPs in the change period is 8 and the MSP is 320 milliseconds, the change period may be 256 SFNs, such that a first change period may be from SFN=0-255, the next change period may be from SFN=256-511, etc. In some embodiments, the change period may begin with an offset from the SFN applied. For example, the offset may be 16, and the first change period may be from SFN=16-271, the next change period may be from SFN=272-527, etc.

In response to determining that the change period has not expired (i.e., determination block 710=“No”), the network entity processor may send the indicated current MSI MAC message in block 722. For example, the MSI MAC message may be sent in the first sub-frame of the first MTCH in the next MSP. The MSI MAC message may be sent to a multi-subscription multi-standby wireless communication device by a eNB serving the multi-subscription multi-standby wireless communication device.

In response to determining that the change period has expired (i.e., determination block 710=“Yes”), the network entity processor may select a LCID rotation scheme in block 714. In this manner, the LCID order may be rotated once a change period. In some embodiments, the rotation scheme may cause the LCID order to be rotated by shifting the LCID order to the left or right one or more LCID.

In block 716, the network entity processor may update the indicated current MSI MAC message by rotating the LCIDs according to the selected LCID rotation scheme to generate a dynamic MSI MAC message. For example, when the selected LCID rotation scheme is to rotate right by one and the original MSI MAC message had the LCID order [1,2,3,4], the update MSI MAC message may have the LCID order [4,1,2,3]. As another example, when the selected LCID rotation scheme is to rotate left by one and the original MSI MAC message had the LCID order [1,2,3,4], the update MSI MAC message may have the LCID order [2,3,4,1]. As a further example, when the selected LCID rotation scheme is to rotate left by two and the original MSI MAC message had the LCID order [1,2,3,4], the update MSI MAC message may have the LCID order [3,4,1,2]. While described as values or rotation (k), such as k=1, k=2, etc., these values of rotation (k) are merely examples, and the values of rotation (k) may be greater than 2, such as 3, 4, 5, etc. Additionally, while described herein as having 4 MTCH's, the number of channels may be less, such as 2 or 3, or greater, such as 5, 6, 7, 8, etc.

In optional block 718, the network entity processor may signal the LCID rotation scheme selected and used to update the MSI MAC message. As examples, the scheme used to rotate LCIDs in dynamic MSI MAC messages may be signaled to multi-subscription multi-standby wireless communication devices in a MAC message, in a user service description (“USD”), in a Radio Resource Control (RRC) message, or in a service provisioning message. In this manner, multi-subscription multi-standby wireless communication devices that do not receive the dynamic MIS MAC message may determine the likely next MTCH based on the signaled rotation scheme.

In block 720, the network entity processor may indicate the dynamic MSI MAC message as the current MSI MAC message, and the network entity processor may send the dynamic MSI MAC message (i.e., the indicated current MSI MAC message) to a multi-subscription multi-standby wireless communication device in block 723. For example, the dynamic MSI MAC message may be sent in the first sub-frame of the first MTCH in the next MSP. In this manner, the MTCH transmission order may be changed by the network entity processor and the multi-subscription multi-standby wireless communication device may identify the new order of the MTCH's.

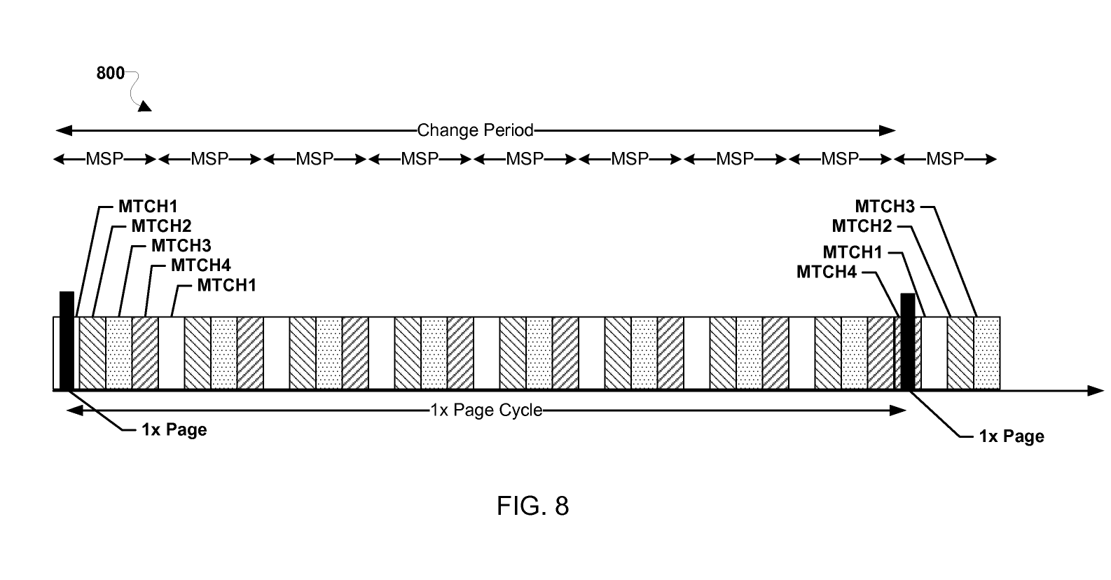

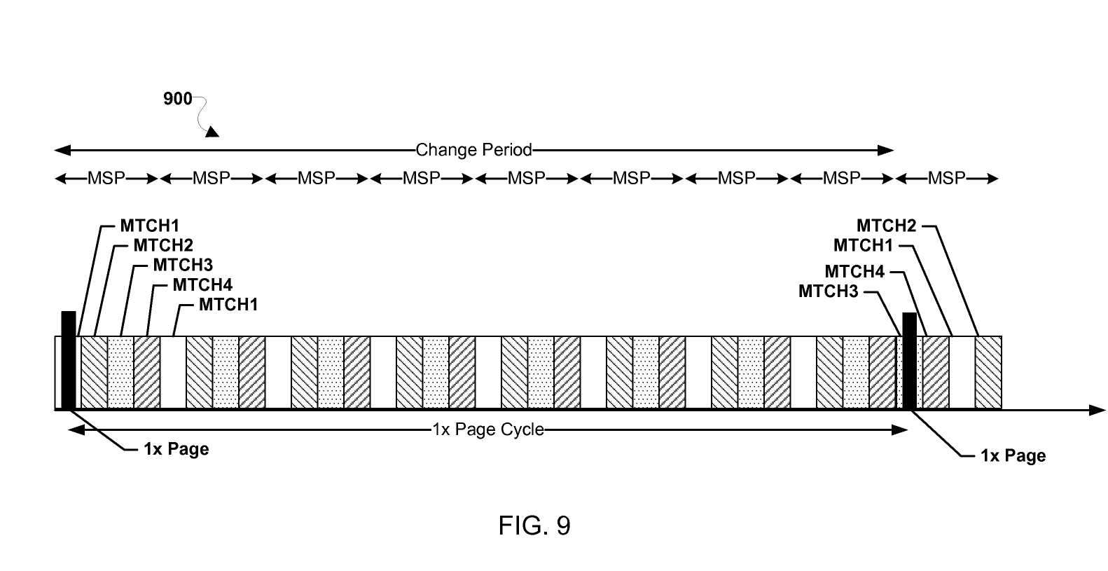

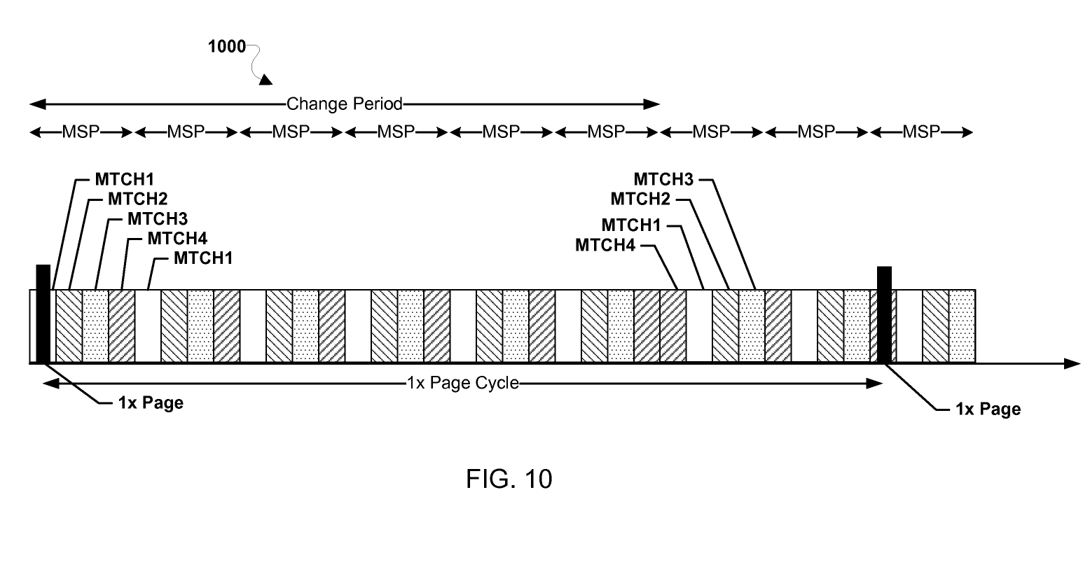

FIGS. 8, 9, and 10 are timeline diagrams illustrating timelines of reception activities of a first RAT and a second RAT sharing an RF resource based on embodiment dynamic MSI MAC messages generated with different LCID rotation schemes according to the operations of method 700 described above with reference to FIG. 7.

With reference to FIGS. 1-10, in the timeline 800, a selected LCID rotation scheme is to rotate right by one. Based on the rotation scheme, when the change period expires after 8 MSPs, the LCID order shifts from the original MTCH1, MTCH2, MTCH3, MTCH4, to MTCH4, MTCH1, MTCH2, MTCH3. In this manner, while the 1× paging cycle caused a tune-away event during MTCH1 during the initial change period, a tune-away event caused by the 1× paging cycle will impact MTCH4 in the second change period. Thus, based on the rotation scheme, over time no MTCH will be impacted by the 1× paging cycle more or less than another MTCH.

In the timeline 900, a selected LCID rotation scheme is to rotate left by two. Based on the rotation scheme, when the change period expires after 8 MSPs, the LCID order shifts from the original MTCH1, MTCH2, MTCH3, MTCH4, to MTCH3, MTCH4, MTCH1, MTCH2. In this manner, while the 1× paging cycle caused a tune-away event during MTCH1 during the initial change period, a tune-away event caused by the 1× paging cycle will impact MTCH3 in the second change period. Thus, based on the rotation scheme, over time no MTCH will be impacted by the 1× paging cycle more or less than another MTCH.

In timeline 1000, a selected LCID rotation scheme is to rotate right by one, but the change period is shorter than the 1× paging cycle. Based on the rotation scheme, when the change period expires after 6 MSPs, the LCID order shifts from the original MTCH1, MTCH2, MTCH3, MTCH4, to MTCH4, MTCH1, MTCH2, MTCH3. In this manner, while the 1× paging cycle caused a tune-away event during MTCH1 during the initial change period, a tune-away event caused by the 1× paging cycle will impact MTCH4 in the second change period. Thus, based on the rotation scheme, over time no MTCH will be impacted by the 1× paging cycle more or less than another MTCH.

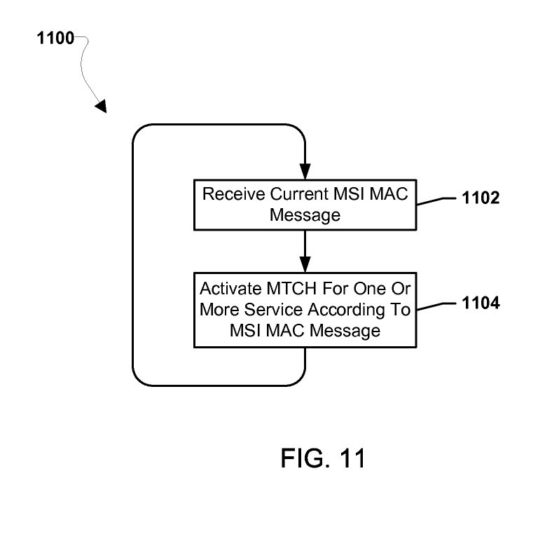

FIG. 11 is a process flow diagram illustrating a method 1100 for activating a Multicast Traffic Channel (MTCH) according to a dynamic MSI MAC message according to various embodiments. With reference to FIGS. 1-11, the method 1100 may be implemented by a processor of multi-subscription multi-standby wireless communication device similar to devices 110, 120, 410, 500 (e.g., the general processor 506, the baseband modem processor 516, the tune-away management unit 530, a separate controller, and/or the like), etc. The operations of method 1100 may be performed by multi-subscription multi-standby wireless communication device being served by a network entity performing operations of method 700, such as a base station or tower processor (e.g., the processor 602 of the eNB 600, the processors of respective eNBs, eNB1.1, eNB1.2, eNB1.n, etc.), a network entity server processor (e.g., the processor of BMSC server 406, MME server 408, or MCE server 407, or processor of another network entity), etc.

In block 1102, the multi-subscription multi-standby wireless communication device processor may receive a current MSI MAC message. For example, the MSI MAC message may be a MSI MAC message with LCIDs and MTCHs rotated according to a selected LCID rotation scheme. In block 1104, the multi-subscription multi-standby wireless communication device processor may activate the MTCH for one or more service according to the MSI MAC message to receive one or more service being transmitted by a base station or tower (e.g., a eNB).

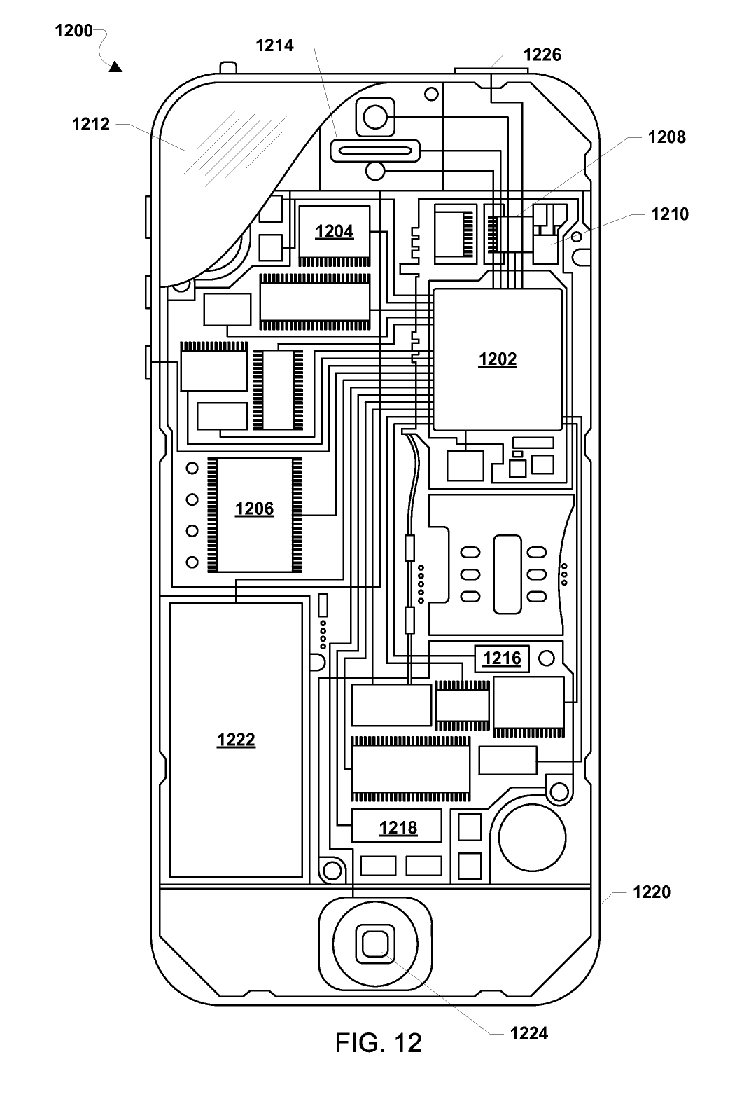

Various embodiments may be implemented in any of a variety of multi-subscription multi-standby wireless communication devices, an example of which (e.g., multi-subscription multi-standby wireless communication device 1200) is illustrated in FIG. 12. In various embodiments, the multi-subscription multi-standby wireless communication device 1200 may be similar to the multi-subscription multi-standby wireless communication devices 110 and 120 described with reference to FIG. 3, the multi-subscription multi-standby wireless communication device 410 described with reference to FIG. 4, and the multi-subscription multi-standby wireless communication device 500 described with reference to FIG. 5. As such, the multi-subscription multi-standby wireless communication device 1100 may implement the method 1100 of FIG. 11.

With reference to FIGS. 1-12, the multi-subscription multi-standby wireless communication device 1200 may include a processor 1202 coupled to a touchscreen controller 1204 and an internal memory 1206. The processor 1202 may be one or more multi-core integrated circuits designated for general or specific processing tasks. The internal memory 1206 may be volatile or non-volatile memory, and may also be secure and/or encrypted memory, or unsecure and/or unencrypted memory, or any combination thereof. The touchscreen controller 1204 and the processor 1202 may also be coupled to a touchscreen panel 1212, such as a resistive-sensing touchscreen, capacitive-sensing touchscreen, infrared sensing touchscreen, etc. Additionally, the display of the multi-subscription multi-standby wireless communication device 1200 need not have touch screen capability.

The multi-subscription multi-standby wireless communication device 1200 may have two or more radio signal transceivers 1208 (e.g., Peanut, Bluetooth, Zig Bee, Wi-Fi, RF radio) and antennae 1210, for sending and receiving communications, coupled to each other and/or to the processor 1202. The transceivers 1208 and antennae 1210 may be used with the above-mentioned circuitry to implement the various wireless transmission protocol stacks and interfaces. The multi-subscription multi-standby wireless communication device 1200 may include one or more cellular network wireless modem chip(s) 1216 coupled to the processor and antennae 1210 that enable communication via two or more cellular networks via two or more radio access technologies.

The multi-subscription multi-standby wireless communication device 1200 may include a peripheral device connection interface 1218 coupled to the processor 1202. The peripheral device connection interface 1218 may be singularly configured to accept one type of connection, or may be configured to accept various types of physical and communication connections, common or proprietary, such as USB, FireWire, Thunderbolt, or PCIe. The peripheral device connection interface 1218 may also be coupled to a similarly configured peripheral device connection port (not shown).

The multi-subscription multi-standby wireless communication device 1200 may also include speakers 1214 for providing audio outputs. The multi-subscription multi-standby wireless communication device 1200 may also include a housing 1220, constructed of a plastic, metal, or a combination of materials, for containing all or some of the components discussed herein. The multi-subscription multi-standby wireless communication device 1200 may include a power source 1222 coupled to the processor 1202, such as a disposable or rechargeable battery. The rechargeable battery may also be coupled to the peripheral device connection port to receive a charging current from a source external to the mobile communication device 1200. The multi-subscription multi-standby wireless communication device 1200 may also include a physical button 1224 for receiving user inputs. The multi-subscription multi-standby wireless communication device 1200 may also include a power button 1226 for turning the multi-subscription multi-standby wireless communication device 1200 on and off.

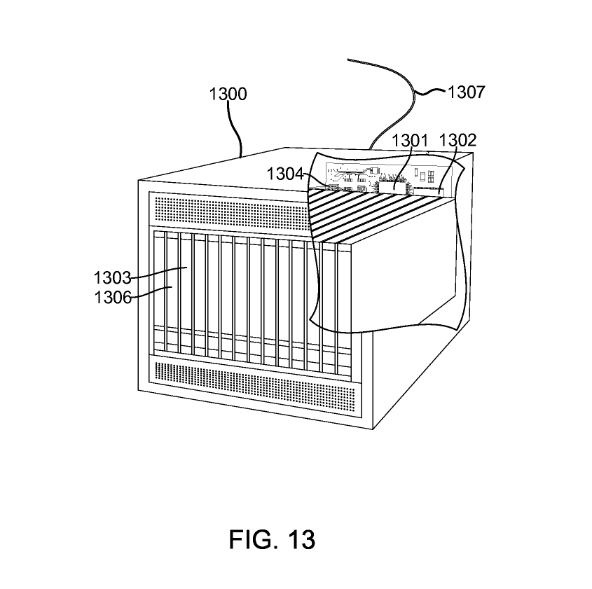

Various embodiments may also be implemented on any of a variety of commercially available server devices within an eNodeB, such as the server 1300 illustrated in FIG. 13. In various embodiments, the server 1300 may be similar to the servers 406, 407, and/or 408 as described with reference to FIG. 4, and may implement the method 700 of FIG. 7. With reference to FIGS. 1-13, such a server 1300 typically includes a processor 1301 coupled to volatile memory 1302 and a large capacity nonvolatile memory, such as a disk drive 1304. The server 1300 may also include a floppy disc drive, compact disc (CD) or DVD disc drive 1306 coupled to the processor 1301. The server 1300 may also include one or more network transceivers 1303, such as a network access port, coupled to the processor 1301 for establishing network interface connections with a communication network 1307, such as a local area network coupled to other announcement system computers and servers, the Internet, the public switched telephone network, and/or a cellular network (e.g., CDMA, TDMA, GSM, PCS, 3G, 4G, LTE, or any other type of cellular network).

The processors described herein, such as processors 506, 516, 530, 602, 1202, and/or 1301, may be any programmable microprocessor, microcomputer or multiple processor chip or chips that can be configured by software instructions (applications) to perform a variety of functions, including the functions of various embodiments described below. In devices, multiple processors 506, 516, 530, 602, 1202, and/or 1301 may be provided as individual processors or multiple processors working in concert, such as one processor dedicated to wireless communication functions and one processor dedicated to running other applications. Typically, software applications may be stored in the internal memory before they are accessed and loaded into the processors 506, 516, 530, 602, 1202, and/or 1301. The processors 506, 516, 530, 602, 1202, and/or 1301 may include internal memory sufficient to store the application software instructions.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present invention is not intended to be limited to the embodiments shown herein but is to be accorded the widest scope consistent with the following claims and the principles and novel features disclosed herein.

What is claimed is:

1. A method for generating a dynamic Multicast Channel (MCH) Scheduling Information (MSI) Media Access Control (MAC) message (MSI MAC message), comprising:
determining whether a change period has expired;
updating a MSI MAC message by rotating Logical Channel Identifiers (LCIDs) in the MSI MAC message according to an LCID rotation scheme to generate a dynamic MSI MAC message in response to determining that the change period has expired; and
sending the dynamic MSI MAC message to a multi-subscription multi-standby wireless communication device.

2. The method of claim 1, wherein the LCID rotation scheme is shifting a LCID order in the MSI MAC message left or right one or more LCID.

3. The method of claim 1, wherein the change period is a multiple of a 1× paging cycle.

4. The method of claim 3, wherein the change period begins at a System Frame Number (SFN) with no offset.

5. The method of claim 1, wherein the change period is not a multiple of a 1× paging cycle.

6. The method of claim 5, wherein the change period begins with an offset.

7. The method of claim 1, wherein sending the dynamic MSI MAC message to a multi-subscription multi-standby wireless communication device comprises sending the dynamic MSI MAC message to the multi-subscription multi-standby wireless communication device via an Evolved Node B (eNB).

8. The method of claim 1, further comprising signaling the LCID rotation scheme to the multi-subscription multi-standby wireless communication device.

9. The method of claim 8, wherein signaling the LCID rotation scheme to the multi-subscription multi-standby wireless communication device comprises signaling the LCID rotation scheme by a MAC message, a user service description (USD), a Radio Resource Control (RRC) message, or a service provisioning message.

10. A device, comprising:
a processor configured with processor-executable instructions to perform operations comprising:
determine whether a change period has expired;
update a Multicast Channel (MCH) Scheduling Information (MSI) Media Access Control (MAC) message (MSI MAC message) by rotating Logical Channel Identifiers (LCIDs) in the MSI MAC message according to a LCID rotation scheme to generate a dynamic MSI MAC message in response to determining that the change period has expired; and
send the dynamic MSI MAC message to a multi-subscription multi-standby wireless communication device.

11. The device of claim 10, wherein the LCID rotation scheme is shifting a LCID order in the MSI MAC message left or right one or more LCID.

12. The device of claim 10, wherein the change period is a multiple of a 1× paging cycle.

13. The device of claim 12, wherein the change period begins at a System Frame Number (SFN) with no offset.

14. The device of claim 10, wherein the change period is not a multiple of a 1× paging cycle.

15. The device of claim 14, wherein the change period begins with an offset.

16. The device of claim 10, wherein the processor is configured to send the dynamic MSI MAC message to a multi-subscription multi-standby wireless communication device via an Evolved Node B (eNB).

17. The device of claim 10, wherein the processor is further configured to signal the LCID rotation scheme to the multi-subscription multi-standby wireless communication device.

18. The device of claim 17, wherein the processor is further configured to signal the LCID rotation scheme to the multi-subscription multi-standby wireless communication device by a MAC message, a user service description (USD), a Radio Resource Control (RRC) message, or a service provisioning message.

19. The device of claim 10, wherein the device is a network entity.

20. The device of claim 19, wherein the device is an Evolved Node B (eNB), a Broadcast Multimedia Service Center (BMSC) server, a Mobility Management Entity (MME) server, or a Multi-Cell/Multicast Coordination Entity (MCE) server.

21. A method implemented on a multi-subscription multi-standby wireless communication device for activating a Multicast Traffic Channel (MTCH) according to a dynamic Multicast Channel (MCH) Scheduling Information (MSI) Media Access Control (MAC) message (MSI MAC message), comprising:
receiving a dynamic MSI MAC message including Logical Channel Identifiers (LCIDs) rotated according to a LCID rotation scheme; and
activating a MTCH for one or more service according to the dynamic MSI MAC message.

22. The method of claim 21, wherein the service is a Dynamic Adaptive Streaming Over Hypertext Transfer Protocol (DASH) service.

23. The method of claim 21, wherein receiving the dynamic MSI MAC message comprises receiving the dynamic MSI MAC message via an Evolved Node B (eNB).

24. A multi-subscription multi-standby wireless communication device, comprising:
a radio frequency (RF) resource configured to support a first subscription and a second subscription; and
a processor coupled to the RF resource and configured with processor-executable instructions to:
receive a dynamic MSI MAC message including Logical Channel Identifiers (LCIDs) rotated according to a LCID rotation scheme; and
activate a Multicast Traffic Channel (MTCH) for one or more service according to the dynamic MSI MAC message.

25. The multi-subscription multi-standby wireless communication device of claim 24, wherein the service is a Dynamic Adaptive Streaming Over Hypertext Transfer Protocol (DASH) service.

26. The multi-subscription multi-standby wireless communication device of claim 24, wherein the processor is configured to receive the dynamic MSI MAC message via an Evolved Node B (eNB).
